(19) United States
(12) Patent Application Publication
(10) Pub. No.: US 2025/0271003 A1
(43) Pub. Date: Aug. 28, 2025

(54) AIR GUIDE STRUCTURE OF AXIAL FLOW FAN AND FAN LIGHT

(71) Applicants: SUZHOU OPPLE LIGHTING CO., LTD., Suzhou City (CN); OPPLE LIGHTING CO., LTD., Shanghai (CN)

(72) Inventors: Xingan LIU, Suzhou City (CN); Yaowei WANG, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 19/094,997

(22) Filed: Mar. 30, 2025

Related U.S. Application Data
(63) Continuation of application No. PCT/CN2023/120894, filed on Sep. 22, 2023.

(30) Foreign Application Priority Data
Sep. 29, 2022 (CN) 202222600278.5

(51) Int. Cl. F04D 29/70; F04D 19/00; F21V 33/00

(52) U.S. Cl. CPC F04D 29/703; F04D 19/002; F21V 33/0096

(57) ABSTRACT

An air guide structure of an axial flow fan and a fan light. The air guide structure includes: a first inner ring, an outer ring and a plurality of first grille bars; the first inner ring and the outer ring are both annular, the outer ring is arranged around a periphery of the first inner ring, and the plurality of first grille bars are evenly spaced in a circumferential direction of the first inner ring, and one end of each of the plurality of first grille bars is connected to the first inner ring and other end of each of the plurality of first grille bars is connected to the outer ring; each of the plurality of first grille bars is in a shape of a twisted sheet extending in a spiral.

### CROSS-REFERENCE TO RELATED APPLICATION(S)

This application is based upon and claims the priority of PCT patent application No. PCT/CN2023/120894 filed on Sep. 22, 2023 which claims priority to the Chinese patent application No. 202222600278.5 filed on Sep. 29, 2022, the entire contents of which are hereby incorporated by reference herein for all purposes.

### TECHNICAL FIELD

Examples of the present disclosure relate to the technical field related to fan light, and in particular to an air guide structure of an axial flow fan and a fan light.

### BACKGROUND

Some air outlet and air guide structure of fans and fan lights have problems of large ventilation resistance, large wind resistance and loud noise due to their poor structural shape design, and the air outlet angle and range are small and fail to meet market demand.

### SUMMARY

The present disclosure is to provide an air guide structure for an axial flow fan and a fan light.

According to one aspect, the present disclosure provides an air guide structure of an axial flow fan, and the air guide structure may include a first inner ring, an outer ring and a plurality of first grille bars; the first inner ring and the outer ring may be both annular, the outer ring may be arranged around a periphery of the first inner ring, and the plurality of first grille bars may be evenly spaced in a circumferential direction of the first inner ring, and one end of each of the plurality of first grille bars may be connected to the first inner ring and other end of each of the plurality of first grille bars may be connected to the outer ring; each of the plurality of first grille bars may be in a shape of a twisted sheet extending in a spiral.

According to another aspect, the present disclosure may provide a fan light, including a light source, a fan blade, a motor, a bracket, and an air guide structure, and the air guide structure may include a first inner ring, an outer ring and a plurality of first grille bars; the first inner ring and the outer ring are both annular.

The outer ring may be arranged around a periphery of the first inner ring, and the plurality of first grille bars may be evenly spaced in a circumferential direction of the first inner ring, and one end of each of the plurality of first grille bars may be connected to the first inner ring and other end of each of the plurality of first grille bars may be connected to the outer ring; each of the plurality of first grille bars may be in a shape of a twisted sheet extending in a spiral; the motor and the air guide structure may be both fixedly connected to the bracket; the fan blade may be connected to the motor and is located between the air guide structure and the bracket; the light source may be fixedly arranged on a periphery of the outer ring of the air guide structure, and/or inside the first inner ring of the air guide structure.

Each of the plurality of first grille bars may include a windward surface in a thickness direction of the each of the plurality of first grille bars, and the windward surface of each of the plurality of first grille bars may face a radial plane of the air guide structure; a rotation plane of the fan blade may be parallel to the radial plane of the air guide structure, an air outlet direction of the fan blade may be perpendicular to the rotation plane of the fan blade, and the windward surface may face the air outlet direction of the fan blade.

It is to be understood that both the foregoing general description and the following detailed description are exemplary and explanatory only and are not restrictive of the present disclosure.

### BRIEF DESCRIPTION OF DRAWINGS

In order to more clearly illustrate the technical solutions in the examples of the present disclosure, the drawings required for use in the description of the examples will be briefly introduced below. The drawings described below are only some examples of the present disclosure. For those skilled in the art, other drawings can be obtained based on these drawings without creative work.

FIG. 1 is a front view of an air guide structure provided by the present disclosure;

FIG. 2 is a cross-sectional view of the air guide structure in FIG. 1 along a diameter direction;

FIG. 3 is a schematic structural diagram of the air guide structure in FIG. 1 from another perspective;

FIG. 4 is a schematic structural diagram of a fan light provided in the present disclosure;

FIG. 5 is a schematic structural diagram of the fan light in FIG. 4 from another viewing angle.

### DETAILED DESCRIPTION

The technical solutions in the examples of the present disclosure are described clearly and completely below. The described examples are only part of the examples of the present disclosure, not all of them. Based on the examples in the present disclosure, all other examples obtained by those skilled in the art without creative work are within the scope of protection of the present disclosure.

The reference numerals in the drawings of the present disclosure may be described as follows:

1—air guide structure; 101—first inner ring; 102—outer ring; 103—first grille bar; 1031—first end; 1032—second end; 1033—windward surface; 104—second inner ring; 105—second grille bar; 106—first angle; 1061—first connection line; 1062—second connection line; 107—second angle; 2—light source; 3—fan blades; 4—motor; 5—bracket.

The present disclosure provides an air guide structure of an axial flow fan and a fan light, which are described in detail below. It should be noted that the order of description of the following examples does not limit the preferred order of the examples of the present disclosure. In the following examples, the description of each example has its own emphasis. For parts that are not described in detail in a certain example, please refer to the relevant description of other examples.

### Example 1

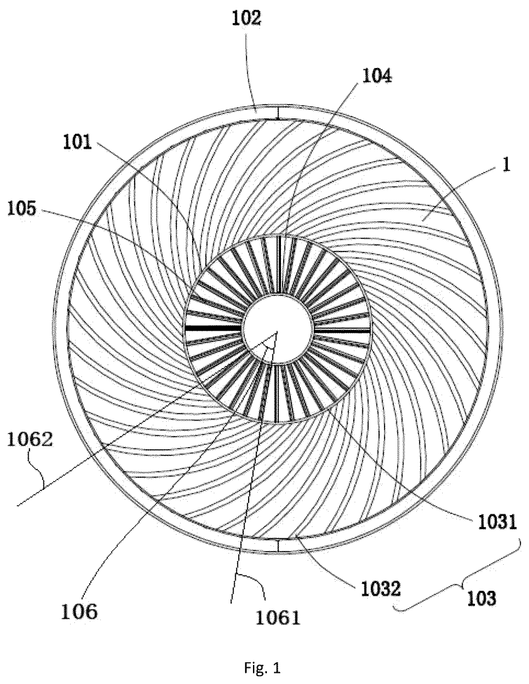

As illustrated by FIGS. 1 to 3, in some examples of the present disclosure, an air guide structure 1 of an axial flow fan includes a first inner ring 101, an outer ring 102, and a plurality of first grille bars 103; the first inner ring 101 and the outer ring 102 are both annular, the outer ring 102 is arranged around the periphery of the first inner ring 101, and the plurality of first grille bars 103 are evenly spaced in a circumferential direction of the first inner ring 101, and one end of each of the plurality of first grille bars 103 is connected to the first inner ring 101, and the other end of each of the plurality of first grille bars 103 is connected to the outer ring 102; each of the plurality of first grille bars 103 is in the shape of a twisted sheet extending in a spiral. The above design reduces the resistance and friction encountered by the air when flowing through the air guide structure 1, thereby reducing the noise generated by the friction between the airflow and the air guide structure 1.

In some examples of the present disclosure, the diameter of the first inner ring 101 is 0.1-0.3 times the diameter of the outer ring 102, and the abovementioned design can reduce the resistance and friction of the air when it flows through the air guide structure 1, thereby reducing the noise generated by the friction between the airflow and the air guide structure 1. It can be understood that, in the case where other parameters remain unchanged, when the diameter of the first inner ring 101 is smaller, the size of the first grille bar 103 in the extension direction is larger, which is more conducive to gathering wind force, increasing the air supply volume of the air guide structure 1, and expanding the air supply range.

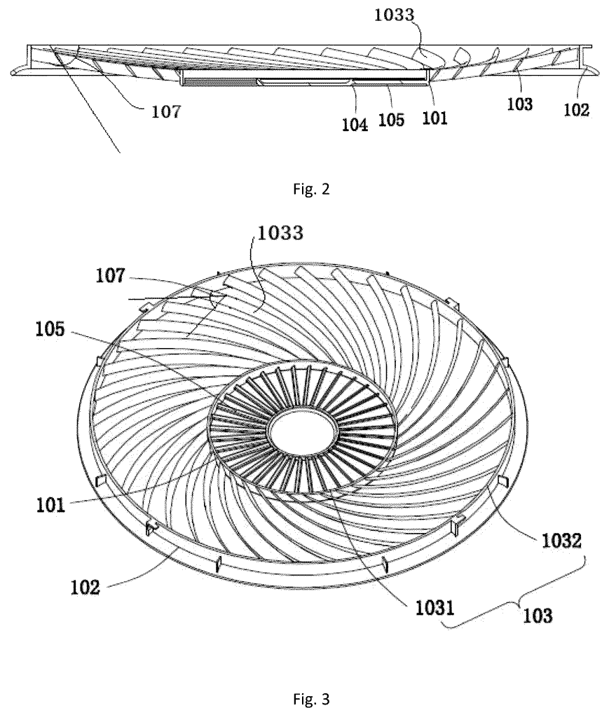

As illustrated by FIG. 2, in some examples of the present disclosure, the radial plane of the first inner ring 101 and the radial plane of the outer ring 102 are not in the same plane and are parallel to each other. It can be understood that the first inner ring 101, the outer ring 102 and the first grille bar 103 enclose a bowl-shaped space, which can partially or completely accommodate the fan blades of the fan or fan light, thereby providing space utilization and reducing the overall volume of the fan or fan light.

Specifically, in some examples of the present disclosure, the vertical distance between the radial plane of the first inner ring 101 and the radial plane of the outer ring 102 is less than or equal to 5-10% of the diameter of the outer ring 102. For example, the vertical distance may be less than or equal to any one of 6%, 7%, 8% or 9.5% of the diameter of the outer ring 102. Of course, in other examples of the present disclosure, the vertical distance may also have other value ranges, which may be selected and adjusted

As illustrated by FIG. 3, in some examples of the present disclosure, the first grille bar 103 includes a first end 1031 and a second end 1032, the first end 1031 of the first grille bar 103 is connected to the first inner ring 101, and the second end 1032 of the first grille bar 103 is connected to the outer ring 102; an orthographic projection of a line connecting the center point of the first end 1031 of the first grille bar 103 and the center of the first inner ring 101 on the radial plane of the outer ring 102 is a first connection line 1061, and an orthographic projection of a line connecting the center point of the second end 1032 of the first grille bar 103 and the center of the first inner ring 101 on the radial plane of the outer ring 102 is a second connection line 1062, the first connection line 1061 and the second connection line 1062 intersect to form a first angle 106, and the value range of the first angle 106 is less than or equal to 75° and greater than 50°. This design enables the air guide structure 1 to present less resistance and friction to the airflow passing through the air guide structure 1, thereby reducing the noise generated when the airflow passes through the air guide structure 1, and has a backflow effect on the airflow passing through the air guide structure 1, thereby expanding the air guide influence radius of the air guide structure 1 and expanding the air supply range of the air guide structure 1.

It can be understood that the center point of the first end 1031 of the first grille bar 103 refers to the center point of the first end 1031 of the first grille bar 103 in the width direction; the center point of the second end 1032 of the first grille bar 103 refers to the center point of the second end 1032 of the first grille bar 103 in the width direction.

In some examples of the present disclosure, the sizes, in the width direction, of the first grille bar 103 at various positions in the extension direction thereof may be different, and may gradually decrease or increase in the direction from the connection position between the first grille bar 103 and the outer ring 102 to the connection position between the first grille bar 103 and the first inner ring 101.

Exemplarily, the numerical value of the first angle 106 can be any one of 55°, 60°, 65° and 70°, and the specific value can be selected and adjusted according to actual needs.

As illustrated by FIG. 1, in some examples of the present disclosure, the air guide structure 1 further includes a second inner ring 104 and a second grille bar 105; the second inner ring 104 is annular and is arranged along the inner circumference of the first inner ring 101; the two ends of the second grille bar 105 are respectively connected to the first inner ring 101 and the second inner ring 104. It can be understood that the shape and size of the second grille bar 105 can be selected and adjusted according to actual needs.

As illustrated by FIG. 2 and FIG. 3, in some examples of the present disclosure, each of the first grille bars 103 has a windward surface 1033 in the thickness direction thereof, and the windward surface 1033 of each of the first grille bars 103 faces the radial plane of the outer ring 102; a second angle 107 is formed between the windward surface 1033 of each of the first grille bars 103 and the radial plane of the outer ring 102, and the value range of the second angle 107 is greater than or equal to 50° and less than 90°; the numerical value and direction of the second angle 107 at each position on the windward surface 1033 of each of the first grille bars 103 have a continuous relationship. This design enables the air guide structure 1 to have less resistance and friction to the airflow passing through the air guide structure 1, so that the noise generated when the airflow passes through is smaller, and it has a backflow effect on the airflow flowing through the air guide structure 1, so that the air guide influence radius of the air guide structure 1 can be expanded, and the air supply range of the air guide structure 1 can be expanded.

Exemplarily, the numerical value of the second angle 107 can be any one of 55°, 60°, 65°, 70°, 75°, 80°, and 85°, and the specific value can be selected and adjusted according to actual needs.

As illustrated by FIGS. 2 and 3, in some examples of the present disclosure, the second angle 107 at each position on the windward surface 1033 of the first grille bar 103 continuously decreases along the direction from the connection position between the first grille bar 103 and the outer ring 102 to the connection position between the first grille bar 103 and the first inner ring 101; the difference between the second angle 107 of the windward surface 1033 at the connection position between the first grille bar 103 and the outer ring 102 and the second angle 107 of the windward surface 1033 at the connection position between the first grille bar 103 and the first inner ring 101 is less than or equal to 5°; the above design can effectively gather wind force and increase air supply while reducing wind resistance and wind noise. Exemplarily, the specific size of the above difference can be set to 3°, 7° or 10°, and the specific value can be selected and adjusted according to actual needs.

### Example 2

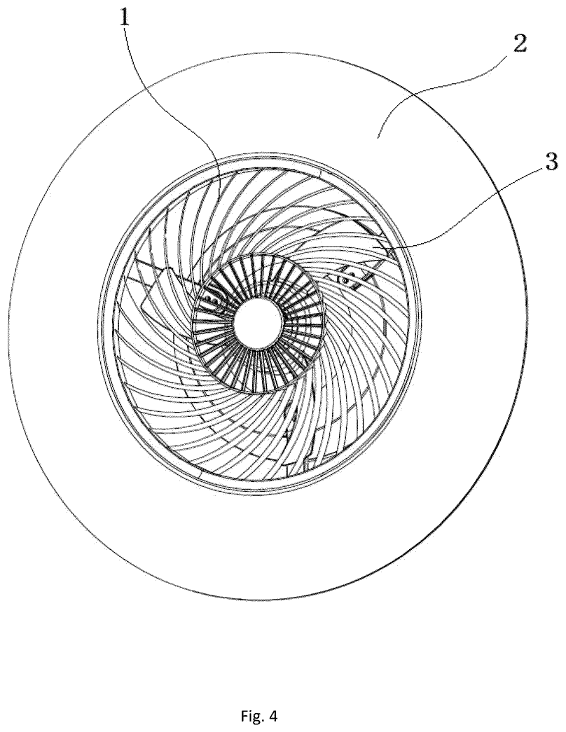

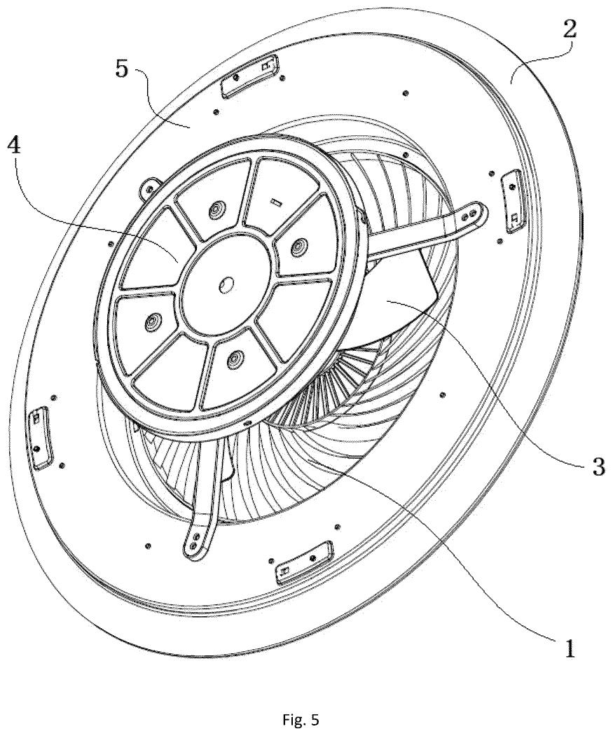

As illustrated by FIGS. 4 and 5, in some examples of the present disclosure, a fan light, includes a light source 2, a fan blade 3, a motor 4, a bracket 5, and an air guide structure 1 as described in the example 1; the motor 4 and the air guide structure 1 are both fixedly connected to the bracket 5, the fan blade 3 is connected to the motor 4, and is located between the air guide structure 1 and the bracket 5; the light source 2 is fixedly arranged on the periphery of the outer ring 102 of the air guide structure 1, and/or, in the first inner ring 101 of the air guide structure 1; each of the first grille bars 103 has a windward surface 1033 in the thickness direction thereof, and the windward surface 1033 of each of the first grille bars 103 faces the radial plane of the air guide structure 1; the rotation plane of the fan blade 3 is parallel to the radial plane of the air guide structure 1, the air outlet direction of the fan blade 3 is perpendicular to the rotation plane of the fan blade 3, and the windward surface 1033 faces the air outlet direction of the fan blade 3. The abovementioned fan light has the advantages of a large air outlet influence range and low wind noise.

As illustrated by FIG. 4 and FIG. 5, in some examples of the present disclosure, the shape and rotation direction of the fan blade 3 are adapted to the extension direction of the first grille bar 103 in the air guide structure 1. The above design can make the airflow generated by the fan blade 3 encounter less resistance when blowing toward the windward surface 1033, thereby reducing the noise generated by the wind resistance.

As illustrated by FIGS. 4 and 5, in some examples of the present disclosure, the windward surface 1033 of each of the first grille bars 103 faces the radial plane of the outer ring 102; the second angle 107 at each position on the windward surface 1033 of the first grille bar 103 continuously decreases along the direction from the connection position between the first grille bar 103 and the outer ring 102 to the connection position between the first grille bar 103 and the first inner ring 101; the difference between the second angle 107 of the windward surface 1033 at the connection position between the first grille bar 103 and the outer ring 102 and the second angle 107 of the windward surface 1033 at the connection position between the first grille bar 103 and the first inner ring 101 is less than or equal to 5°; the first grille bars 103 of the abovementioned shape can reduce wind resistance and reduce wind noise.

It can be understood that the numerical value and direction of the second angle 107 at various positions on the windward surface 1033 are in a continuous relationship, that is, assuming that the magnitude of the second angle 107 at a certain point on the windward surface 1033 is 75°, then the magnitude of the second angle 107 at each adjacent point in the vicinity of the point is based on 75° and is continuous, which is determined by the nature of the windward surface 1033 being an arc surface extending in a spiral shape. In some examples of the present disclosure, the maximum fluctuation range of the second angle 107 at various positions on the windward surface 1033 in numerical value does not exceed 10°, and the maximum fluctuation range allowed can also be selected and adjusted according to actual needs; it can be understood that the maximum fluctuation value of the second angle 107 generally appears at the connection position between the windward surface 1033 and the first inner ring 101, and the minimum fluctuation value of the second angle 107 generally appears at the connection position between the windward surface 1033 and the outer ring 102. In some examples of the present disclosure, the difference in numerical value of the second angle 107 at these two positions does not exceed 5°.

In some examples of the present disclosure, the second angle 107 is greater than or equal to 50° and less than or equal to 90°. The above design can make the airflow encounter less resistance when blowing toward the windward surface 1033, thereby reducing the noise generated by wind resistance, and has a backflow effect on the airflow flowing through the air guide structure 1, thereby expanding the air guide influence radius of the air guide structure 1 and expanding the air supply range of the air guide structure 1. Exemplarily, the value of the second angle 107 can be any one of 55°, 60°, 65°, 70°, 75°, 80°, and 85°, and the specific value can be selected and adjusted according to actual needs.

In some examples of the present disclosure, the light source 2 includes a light panel, a light shade and a light bead; the light bead is arranged on the light panel, and the light shade covers on the light panel and thus encloses the light bead; the number of the light bead and its distribution on the light panel can be designed and selected according to actual needs.

In some examples of the present disclosure, the fan light further includes a nut, the nut is disposed between the air guide structure 1 and the fan blades 3, and fixes the air guide structure 1 and the fan blades 3 by tightening and locking.

### Technical Solutions

The purpose of the present disclosure is to provide an air guide structure for an axial flow fan and a fan light, so as to solve the problems of large ventilation resistance and loud noise of some fans and fan lights.

In order to achieve the above purpose, the present disclosure proposes the following technical solutions: an air guide structure of an axial flow fan, the air guide structure includes a first inner ring, an outer ring and a plurality of first grille bars; the first inner ring and the outer ring are both annular, the outer ring is arranged around a periphery of the first inner ring, and the plurality of first grille bars are evenly spaced in a circumferential direction of the first inner ring, and one end of each of the plurality of first grille bars is connected to the first inner ring and other end of each of the plurality of first grille bars is connected to the outer ring; each of the plurality of first grille bars is in a shape of a twisted sheet extending in a spiral.

In some examples of the present disclosure, a diameter of the first inner ring is 0.1-0.3 times a diameter of the outer ring.

In some examples of the present disclosure, a radial plane of the first inner ring and a radial plane of the outer ring are not in the same plane and are parallel to each other.

In some examples of the present disclosure, a vertical distance between the radial plane of the first inner ring and the radial plane of the outer ring is less than or equal to 5-10% of a diameter of the outer ring.

In some examples of the present disclosure, each first grille bar of the plurality of first grille bars includes a first end and a second end, the first end of the first grille bar is connected to the first inner ring, and the second end of the first grille bar is connected to the outer ring; an orthographic projection of a line connecting a center point of the first end of the first grille bar and a center of the first inner ring on a radial plane of the outer ring is a first connection line; an orthographic projection of a line connecting a center point of the second end of the first grille bar and the center of the first inner ring on the radial plane of the outer ring is a second connection line; the first connection line and the second connection line intersect to form a first angle, and a value range of the first angle is less than or equal to 75° and greater than 50°.

In some examples of the present disclosure, the air guide structure further includes a second inner ring and a second grille bar; the second inner ring is annular and is arranged along an inner circumference of the first inner ring; two ends of the second grille bar are respectively connected to the first inner ring and the second inner ring.

In some examples of the present disclosure, each of the plurality of first grille bars includes a windward surface in a thickness direction of the each of the plurality of first grille bars, and the windward surface of each of the plurality of first grille bars faces a radial plane of the outer ring; a second angle is formed between the windward surface of each of the plurality of first grille bars and the radial plane of the outer ring, and a value range of the second angle is greater than or equal to 50° and less than 90°; a numerical value and a direction of the second angle at each position on the windward surface of each of the first grille bars are in continuous relationship.

In some examples of the present disclosure, the second angle at each position on the windward surface of each first grille bar of the plurality of first grille bars continuously decreases along a direction from a connection position between the first grille bar and the outer ring to a connection position between the first grille bar and the first inner ring; a difference between the second angle of the windward surface at the connection position between the first grille bar and the outer ring and the second angle of the windward surface at the connection position between the first grille bar and the first inner ring is less than or equal to 5°.

In order to achieve the above purpose, the present disclosure further proposes the following technical solutions: a fan light, including a light source, a fan blade, a motor, a bracket, and an air guide structure; the air guide structure includes a first inner ring, an outer ring and a plurality of first grille bars; the first inner ring and the outer ring are both annular, the outer ring is arranged around a periphery of the first inner ring, and the plurality of first grille bars are evenly spaced in a circumferential direction of the first inner ring, and one end of each of the plurality of first grille bars is connected to the first inner ring and other end of each of the plurality of first grille bars is connected to the outer ring; each of the plurality of first grille bars is in a shape of a twisted sheet extending in a spiral; the motor and the air guide structure are both fixedly connected to the bracket; the fan blade is connected to the motor and is located between the air guide structure and the bracket; the light source is fixedly arranged on a periphery of the outer ring of the air guide structure, and/or inside the first inner ring of the air guide structure; each of the plurality of first grille bars includes a windward surface in a thickness direction of the each of the plurality of first grille bars, and the windward surface of each of the plurality of first grille bars faces a radial plane of the air guide structure; a rotation plane of the fan blade is parallel to the radial plane of the air guide structure, an air outlet direction of the fan blade is perpendicular to the rotation plane of the fan blade, and the windward surface faces the air outlet direction of the fan blade.

In some examples of the present disclosure, a shape and a rotation direction of the fan blade are both adapted to an extension direction of each of the plurality of first grille bars in the air guide structure.

In some examples of the present disclosure, the windward surface of each of the plurality of first grille bars faces the radial plane of the outer ring; a second angle is formed between the windward surface of each of the plurality of first grille bars and the radial plane of the outer ring, and a value range of the second angle is greater than or equal to 50° and less than 90°; the second angle at each position on the windward surface of each first grille bar of the plurality of first grille bars continuously decreases along a direction from a connection position between the first grille bar and the outer ring to a connection position between the first grille bar and the first inner ring; a difference between the second angle of the windward surface at the connection position between the first grille bar and the outer ring and the second angle of the windward surface at the connection position between the first grille bar and the first inner ring is less than or equal to 5°.

### Beneficial Effects

1. The shape and design of the air guide structure provided in the present disclosure reduce the resistance to air discharge from the fan blades, that is, reduce the ventilation resistance, thereby reducing the noise caused by air flow friction.

2. The shape and design of the air guide structure provided in the present disclosure have a backflow effect on the air outlet of the fan blades, thereby expanding the influence radius of the air outlet of the fan blades and expanding the air supply range.

The above is only a specific implementation of the present disclosure, but the protection scope of the present disclosure is not limited thereto. Any technician familiar with the technical field can easily think of changes or replacements within the technical scope disclosed in the present disclosure, which should be included in the protection scope of the present disclosure. Therefore, the protection scope of the present disclosure shall be based on the protection scope of the claims. In addition, the specification uses specific examples to illustrate the principles and implementation methods of the present disclosure. The description of the above examples is only used to help understand the method and its core idea of the present disclosure. The content of this specification should not be understood as a limitation on the present disclosure.

1. An air guide structure of an axial flow fan, comprising a first inner ring, an outer ring and a plurality of first grille bars, wherein:
the first inner ring and the outer ring are both annular, the outer ring is arranged around a periphery of the first inner ring, and the plurality of first grille bars are evenly spaced in a circumferential direction of the first inner ring, and one end of each of the plurality of first grille bars is connected to the first inner ring and other end of each of the plurality of first grille bars is connected to the outer ring; and
each of the plurality of first grille bars is in a shape of a twisted sheet extending in a spiral.

2. The air guide structure according to claim 1, wherein a diameter of the first inner ring is 0.1-0.3 times a diameter of the outer ring.

3. The air guide structure according to claim 1, wherein a radial plane of the first inner ring and a radial plane of the outer ring are not in the same plane and are parallel to each other.

4. The air guide structure according to claim 1, wherein a vertical distance between the radial plane of the first inner ring and the radial plane of the outer ring is less than or equal to 5-10% of a diameter of the outer ring.

5. The air guide structure according to claim 1, wherein:
each first grille bar of the plurality of first grille bars comprises a first end and a second end, the first end of the first grille bar is connected to the first inner ring, and the second end of the first grille bar is connected to the outer ring; and
an orthographic projection of a line connecting a center point of the first end of the first grille bar and a center of the first inner ring on a radial plane of the outer ring is a first connection line; an orthographic projection of a line connecting a center point of the second end of the first grille bar and the center of the first inner ring on the radial plane of the outer ring is a second connection line; the first connection line and the second connection line intersect to form a first angle, and a value range of the first angle is less than or equal to 75° and greater than 50°.

6. The air guide structure according to claim 1, further comprising a second inner ring and a second grille bar, wherein:
the second inner ring is annular and is arranged along an inner circumference of the first inner ring; and
two ends of the second grille bar are respectively connected to the first inner ring and the second inner ring.

7. The air guide structure according to claim 1, wherein:
each of the plurality of first grille bars comprises a windward surface in a thickness direction of the each of the plurality of first grille bars, and the windward surface of each of the plurality of first grille bars faces a radial plane of the outer ring;
a second angle is formed between the windward surface of each of the plurality of first grille bars and the radial plane of the outer ring, and a value range of the second angle is greater than or equal to 50° and less than 90°; and
a numerical value and a direction of the second angle at each position on the windward surface of each of the first grille bars are in continuous relationship.

8. The air guide structure according to claim 7, wherein:
the second angle at each position on the windward surface of each first grille bar of the plurality of first grille bars continuously decreases along a direction from a connection position between the first grille bar and the outer ring to a connection position between the first grille bar and the first inner ring; and
a difference between the second angle of the windward surface at the connection position between the first grille bar and the outer ring and the second angle of the windward surface at the connection position between the first grille bar and the first inner ring is less than or equal to 5°.

9. A fan light, comprising a light source, a fan blade, a motor, a bracket, and an air guide structure, wherein:
the air guide structure comprises a first inner ring, an outer ring and a plurality of first grille bars;
the first inner ring and the outer ring are both annular, the outer ring is arranged around a periphery of the first inner ring, and the plurality of first grille bars are evenly spaced in a circumferential direction of the first inner ring, and one end of each of the plurality of first grille bars is connected to the first inner ring and other end of each of the plurality of first grille bars is connected to the outer ring;
each of the plurality of first grille bars is in a shape of a twisted sheet extending in a spiral;
the motor and the air guide structure are both fixedly connected to the bracket; the fan blade is connected to the motor and is located between the air guide structure and the bracket;
the light source is fixedly arranged on a periphery of the outer ring of the air guide structure, and/or inside the first inner ring of the air guide structure;
each of the plurality of first grille bars comprises a windward surface in a thickness direction of the each of the plurality of first grille bars, and the windward surface of each of the plurality of first grille bars faces a radial plane of the air guide structure; and
a rotation plane of the fan blade is parallel to the radial plane of the air guide structure, an air outlet direction of the fan blade is perpendicular to the rotation plane of the fan blade, and the windward surface faces the air outlet direction of the fan blade.

10. The fan light according to claim 9, wherein the diameter of the first inner ring is 0.1-0.3 times the diameter of the outer ring.

11. The fan light according to claim 9, wherein a radial plane of the first inner ring and a radial plane of the outer ring are not in the same plane and are parallel to each other.

12. The fan light according to claim 9, wherein a vertical distance between the radial plane of the first inner ring and the radial plane of the outer ring is less than or equal to 5-10% of a diameter of the outer ring.

13. The fan light according to claim 9, wherein:
each first grille bar of the plurality of first grille bars comprises a first end and a second end, the first end of the first grille bar is connected to the first inner ring, and the second end of the first grille bar is connected to the outer ring; and
an orthographic projection of a line connecting a center point of the first end of the first grille bar and a center of the first inner ring on a radial plane of the outer ring is a first connection line; an orthographic projection of a line connecting a center point of the second end of the first grille bar and the center of the first inner ring on the radial plane of the outer ring is a second connection line; the first connection line and the second connection line intersect to form a first angle, and a value range of the first angle is less than or equal to 75° and greater than 50°.

14. The fan light according to claim 9, wherein:
the air guide structure further comprises a second inner ring and a second grille bar;
the second inner ring is annular and is arranged along an inner circumference of the first inner ring; and
two ends of the second grille bar are respectively connected to the first inner ring and the second inner ring.

15. The fan light according to claim 9, wherein a shape and a rotation direction of the fan blade are both adapted to an extension direction of each of the plurality of first grille bars in the air guide structure.

16. The fan light according to claim 9, wherein:
the windward surface of each of the plurality of first grille bars faces the radial plane of the outer ring;
a second angle is formed between the windward surface of each of the plurality of first grille bars and the radial plane of the outer ring, and a value range of the second angle is greater than or equal to 50° and less than 90°;
the second angle at each position on the windward surface of each first grille bar of the plurality of first grille bars continuously decreases along a direction from a connection position between the first grille bar and the outer ring to a connection position between the first grille bar and the first inner ring; and
a difference between the second angle of the windward surface at the connection position between the first grille bar and the outer ring and the second angle of the windward surface at the connection position between the first grille bar and the first inner ring is less than or equal to 5°.
